(19) United States
(12) Patent Application Publication
(10) Pub. No.: US 2015/0021389 A1
(43) Pub. Date: Jan. 22, 2015

(54) VEHICLE TOLLING SYSTEM WITH OCCUPANCY DETECTION

(71) Applicant: Amtech Systems, Inc, Albuquerque, NM (US)

(72) Inventor: Kelly Gravelle, Poway, CA (US)

(21) Appl. No.: 14/336,510

(22) Filed: Jul. 21, 2014

Related U.S. Application Data
(60) Provisional application No. 61/856,900, filed on Jul. 22, 2013.

(51) Int. Cl. G06Q 50/30; G06Q 20/10; G06K 17/00

(52) U.S. Cl. CPC G06Q 50/30; G06K 17/0029; G06Q 20/10
USPC 235/375

(57) ABSTRACT

A system is disclosed for assessing roadway toll charges based on vehicle occupancy level based on occupants each having an electronic fob with a unique indentifier. The system includes: a vehicle-mounted RFID fob reader; a plurality of RFID fobs; an RFID toll tag associated with the vehicle; an RFID toll tag interrogator located at a tolling point; and a fob reader interrogator located at the tolling point. Each fob is associated with a vehicle occupant and the RFID fob reader interrogates the fobs to determine the number of fobs in the vehicle and thus determine vehicle occupancy. A method for assessing charges based on this system is also disclosed.

### CROSS-REFERENCE TO RELATED APPLICATIONS

This utility application is a non-provisional patent application which claims the benefit under 35 U.S.C. §119(e) of Provisional Application Ser. No. 61/856,900 filed on Jul. 22, 2013 and entitled Vehicle Tolling System with Occupancy Detection, the entire disclosure of which is incorporated by reference herein

### FIELD OF THE INVENTION

The invention relates generally to the field of automated vehicle tolling and particularly to variable rate tolling based on vehicle occupancy level.

### BACKGROUND

In the field of automated tolling for roadway usage, there exist incentivized programs for increased vehicle occupancy. The premise is to reward drivers for carpooling with other riders so as to reduce the number of vehicles on the roadway. One form of incentive is reduced toll rates based on vehicle occupancy level. Where automated tolling systems are in place, means are necessary for broadcasting to the tolling authority a declared vehicle occupancy level. Since vehicle occupancy varies with each trip, this requires the operator to take some action to adjust occupancy level each time he or she begins travel on a toll road. Because drivers are apt to forget to adjust occupancy level and may attempt to do so while driving, thus creating a distraction, it would be advantageous to be able to automatically detect and report vehicle occupancy level each time a trip is taken. The present invention addresses this need

The inventor has made related disclosures in U.S. patent application Ser. No. 12/533,067 filed Jul. 31, 2009, Ser. No. 12/915,739 filed Oct. 29, 2010, and Ser. No. 13/685,101 filed Nov. 26, 2012, the entire disclosures of which are incorporated by reference herein.

### SUMMARY OF THE INVENTION

A system is disclosed for assessing roadway toll charges based on vehicle occupancy level based on occupants each having an electronic fob with a unique indentifier. The system includes: a vehicle-mounted RFID fob reader; a plurality of RFID fobs; an RFID toll tag associated with the vehicle; an RFID toll tag interrogator located at a tolling point; and a fob reader interrogator located at the tolling point. Each fob is associated with a vehicle occupant and the RFID fob reader interrogates the fobs to determine the number of fobs in the vehicle and thus determine vehicle occupancy. A method for assessing charges based on this system is also disclosed.

### FIGURES

FIG. 1 is a system diagram of an exemplary FOB-based occupancy level detection and reporting system.

### DETAILED SPECIFICATION

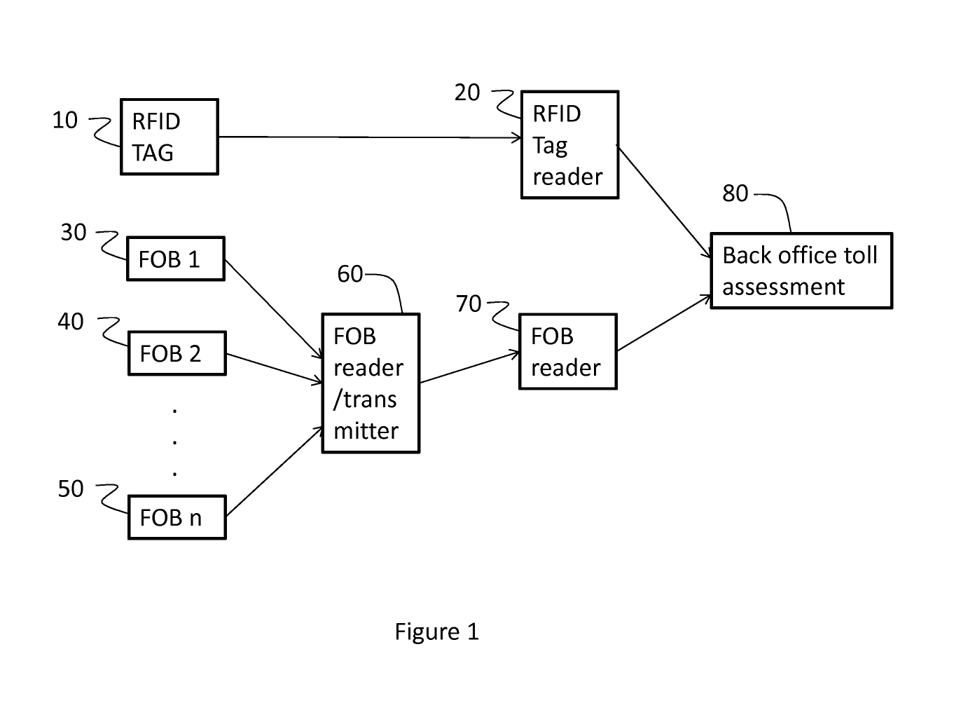

An exemplary system is shown in FIG. 1. In the inventive system, each rider in a vehicle carries an RFID fob 30, 40, 50, which can be easily attached to a key chain or kept in a handbag, back pack, briefcase or the like. RFID fobs are well known in the art and are typically used for access control. Each traveler must register one time to obtain a fob. The vehicle has a small fob interrogator 60 installed, which in an embodiment can be connected to the vehicle's onboard diagnostic port for power. Each fob has a unique serial number or other designation that is transmitted when read by the in-vehicle fob interrogator 60. The fob interrogator 60 reads all active fobs in the vehicle and determines the number of occupants. The fob interrogator 60 also has a transceiver or simple transmitter for relaying the occupant count to the tolling authority. In an embodiment, at each toll point, there is a reader 70 installed to read the occupancy count from the fob interrogator 60. The reader 70 is separate from the RFID toll system reader 20, which independently tracks the vehicle RFID tag 10 and reports that the vehicle crossed the toll point to the back office. The fob system reader 70 can be a single low cost data beacon that covers as many as 8 lanes of traffic. Since the on-board fob reader 60 is registered to the vehicle, the toll system back office can associate the fob count with the RFID vehicle tag 20 and make the appropriate toll charge for that vehicle based on occupancy level.

Because the fob interrogation system is independent from the RFID tolling system, this device can be implemented without changing existing tolling infrastructure and can be offered, for example, as an option to tag holders who frequently travel with other riders, such as commuters who car pool.

An exemplary method for charging a variable toll rate based on the fob system includes the following steps: providing a vehicle with an RFID tag and a fob reader each uniquely associated with the vehicle; providing vehicle occupants with fobs, each fob having a unique identifier; interrogating the fobs by the in vehicle fob reader; determining a fob count; interrogating the RIFD tag at a tolling point; interrogating the fob reader at said tolling point to obtain said fob count; and assessing a toll charge for the vehicle based on said fob count.

The embodiments described herein are intended to be illustrative only and are not meant to limit the scope of the invention.

1. A system for determining vehicle occupancy comprising:
a vehicle-mounted RFID fob reader and
a plurality of RFID fobs;
wherein each fob is associated with a vehicle occupant and wherein said RFID fob reader interrogates said fobs to determine the number of fobs in the vehicle and thus determine vehicle occupancy.

2. The system of claim 1, wherein said fobs are either active devices comprising a battery powered receiver and transmitter or backscatter devices.

3. A system for assessing roadway toll charges based on vehicle occupancy level comprising:
a vehicle-mounted RFID fob reader
a plurality of RFID fobs;
an RFID toll tag associated with the vehicle;
an RFID toll tag interrogator located at a tolling point; and
a fob reader interrogator located at said tolling point;
wherein each fob is associated with a vehicle occupant and wherein said RFID fob reader interrogates said fobs to determine the number of fobs in the vehicle and thus determine vehicle occupancy; and
wherein said RFID toll tag interrogator determines that said vehicle has passed said tolling point, said fob reader interrogator reads said fob count and;
wherein a toll charge is assessed based on the vehicle passing said tolling point and said fob count.

4. The system of claim 3, wherein said fob count and an identifier associated with said RFID tag are transmitted to a central office where said toll charge is determined.

5. A method of assessing a roadway toll charge based on vehicle occupancy comprising the steps of:
providing a vehicle with an RFID tag and a fob reader each uniquely associated with the vehicle;
providing vehicle occupants with fobs, each fob having a unique identifier;
interrogating said fobs by the in-vehicle fob reader;
determining a fob count;
interrogating the RIFD tag at a tolling point;
interrogating the fob reader at said tolling point to obtain said fob count; and
assessing a toll charge for the vehicle based on said fob count.
